(19) United States
(12) Patent Application Publication
(10) Pub. No.: US 2011/0229690 A1
(43) Pub. Date: Sep. 22, 2011

(54) CATIONIC FIBERGLASS SIZE

(75) Inventors: Jerry HC Lee, Columbus, OH (US); Leonard J. Adzima, Pickerington, OH (US); Scott W. Schweiger, Newark, OH (US); Liang Chen, New Albany, OH (US)

(73) Assignee: OCV INTELLECTUAL CAPITAL, LLC, Toledo, OH (US)

(21) Appl. No.: 13/048,364

(22) Filed: Mar. 15, 2011

Related U.S. Application Data
(63) Continuation of application No. 12/004,875, filed on Dec. 21, 2007, now abandoned.

(51) Int. Cl. E04D 3/06; B32B 5/02; D04H 1/58; C08L 75/04; C08L 71/02

(52) U.S. Cl. 428/145; 428/391; 524/590; 525/409

(57) ABSTRACT

A sizing composition for reinforcement fibers that includes a cationic modified polyurethane dispersion, one or more silane coupling agents, and at least one lubricant is provided. The cationic modified polyurethane dispersion includes a dual end-capped polyurethane selected from a silane-terminated polyurethane, a ketoxime-terminated polyurethane, or a hybrid silane/ketoxime-terminated polyurethane where one end of the polyurethane is terminated with a silane group and the opposing end is terminated with a ketoxime group. The size composition is applied to reinforcement fibers and formed into chopped strand, wet-laid mats that can be used for a variety of purposes, including roofing products. Chopped strand mats formed from fibers sized with the inventive sizing composition maintains or improves the dry tear strengths and wet strengths compared to chopped strand mats made from fibers sized with a commercial sizing composition that does not contain a modified cationic polyurethane dispersion (e.g., SPUD).

### RELATED APPLICATION

This application is a continuation of the U.S. non-provisional application having Ser. No. 12/004,875, filed on Dec. 21, 2007, and entitled CATIONIC FIBERGLASS SIZE, which is hereby incorporated by reference in its entirety.

### TECHNICAL FIELD AND INDUSTRIAL APPLICABILITY OF THE INVENTION

The present invention relates generally to a sizing composition for reinforcement fibers, and more particularly, to a sizing composition for reinforcement fibers that incorporates cationically modified polyurethanes. A roofing mat formed from a reinforcing fiber material sized with the sizing composition is also provided.

### BACKGROUND OF THE INVENTION

Glass fibers are commonly used as reinforcements in the building composite industry because they do not shrink or stretch in response to changing atmospheric conditions. Roofing materials such as roofing shingles, roll roofing, and commercial roofing are commonly constructed of a glass fiber mat, an asphalt coating on the fibrous mat, and a surface layer of granules embedded in the asphalt coating.

Typically, the glass fibers are formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the fibers may be gathered into one or more strands and wound into a package or chopped while wet and collected. The collected continuous strands or chopped strands can then be dried or the chopped strands may be packaged in their wet condition as wet chopped fiber strands (WUCS). The chopped strands may contain hundreds or thousands of individual glass fibers. The steps taken in conjunction with the fibers depend upon the ultimate use of the glass fibers.

To form a chopped strand mat suitable for use in a roofing material, the wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. The slurry containing the fibers is deposited onto a moving screen where a substantial portion of the water is removed to form a web. A polymeric binder is then applied, and the resulting mat is heated to remove the remaining water and cure the binder. A urea-formaldehyde binder is typically utilized due to its low cost. The formed non-woven mat is an assembly of randomly dispersed, individual glass filaments. Properties such as tear strength, dry tensile strength, and wet tensile strength are commonly measured to determine the usefulness of the chopped strand mat in roofing applications. One especially important property for a roofing mat is the retention of tear strength. The tear strength provides one estimation of the durability of the roofing mat.

Conventional sizing formulations for glass fibers that are utilized to form roofing mats typically contain a polyvinyl alcohol film forming agent, a coupling agent, and a lubricant. The polyvinyl alcohol functions as a processing aid and protects the glass fibers from breaking during the formation of the fibers. However, once the fibers are chopped and placed into the white water, the polyvinyl alcohol tends to wash off the fibers and into the white water. In the white water, the polyvinyl alcohol precipitates out of solution. This precipitate can be detrimental to the manufacturing line in that the precipitate can clog the tanks In such a situation, the manufacturing line must be stopped to clean the tanks and remove the precipitate. Additionally, polyvinyl alcohol can cause storage problems, particularly in warm environments. As water evaporates from the sizing composition, the polyvinyl alcohol tends to form a film covering the surface of the aqueous composition within the storage container. Further, the large number of hydroxyl groups present in the polyvinyl alcohol encourages undesirable microbe activity in the storage containers.

Thus, there remains a need in the art for a sizing composition for wet chopped fibers used in a wet-laid process that reduces or eliminates the formation of precipitates in the white water and maintains or exceeds the dry tensile and tear strengths of wet-laid mats formed with the sized fibers.

### SUMMARY OF THE INVENTION

It is an object of the present invention to provide a sizing composition for reinforcement fibers that are used to form wet-laid, chopped strand mats. In preferred embodiments, the reinforcement fibers are wet chopped strand glass fibers (WUCS). The sizing composition includes a cationic modified polyurethane dispersion, a silane coupling agent package, and at least one lubricating surfactant. Optional components such as rheology modifiers, fillers, biocides, and pH modifiers may also be included in the composition. The silane coupling agent package includes two or more silane coupling agents. Preferably, the silane coupling agent package includes an amino silane and a ureido silane. As a result of the bonding of the film former to the glass fibers, the cationic polyurethane dispersion is not washed off in white water and may actively participate in the formation of a non-woven mat.

It is another object of the present invention to provide a reinforcing fiber for use in forming a non-woven, chopped strand mat. The fiber may be a glass fiber, a synthetic fiber, a carbon fiber, a polyaramide fiber, or a natural fiber. Preferably, the fiber is a glass fiber. The fiber is at least partially coated with a sizing composition that includes a cationic modified polyurethane dispersion, a silane coupling agent package, and one or more lubricating surfactants. The coupling agent package may include an amino silane and a ureido silane. Optional components such as rheology modifiers, fillers, biocides, and pH modifiers may also be included in the composition. In addition, the size composition is free of polyvinyl alcohol.

It is yet another object of the present invention to provide a roofing mat formed of a plurality of randomly oriented, enmeshed reinforcement fibers. Desirably, the fibers are glass fibers. The reinforcing fibers are at least partially coated with a sizing composition that includes at least one film forming agent, one or more silane coupling agents, and one or more lubricating surfactants. The film forming agent is a cationic modified polyurethane dispersion. The polyurethane may be end-capped with silane groups, ketoxime groups, or with a silane group and a ketoxime group. A roofing mat may be formed by a wet-laid process in which chopped fibers are dispersed in white water and formed into a chopped strand mat. A binder is applied to a top surface of the mat and cured to form the roofing mat. Asphalt may at least partially coat the bottom surface of the mat. To form a roofing shingle, the asphalt-coated mat may be cut into a desired shape.

It is an advantage of the present invention that a polyurethane end-capped with silane groups can react with the —OH groups present on the glass surface to provide crosslinking between the film former and the glass surface.

It is another advantage of the present invention that the modified polyurethane film former remains on the glass fiber surface after the subsequent mat conversion process in the white water.

It is a further advantage of the present invention that polyurethanes end-capped with ketoxime groups will regenerate —NCO groups which may then react with the urea formaldehyde binder on the mat.

It is yet another advantage of the present invention that chopped strand mats formed from fibers sized with the inventive sizing composition maintain or exceed dry tear and tensile strengths compared to chopped strand mats formed from fibers sized with a commercial sizing composition that does not contain a modified cationic polyurethane dispersion.

It is a feature of the present invention that a silane-terminated polyurethane, a ketoxime-terminated polyurethane, or a silane/ketoxime-terminated polyurethane may be produced and utilized in the cationic polyurethane dispersion film forming agent.

It is also a feature of the present invention that the cationic polyurethane dispersion may be end-capped with a silane group and/or a ketoxime group.

It is a further feature of the present invention that a blocking agent and a capping agent can be positioned at opposing ends of the polyurethane prepolymer.

It is also a feature of the present invention that there is little or no formation of precipitates in the white water tank.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

The terms “film forming agent” and “film former” may be used interchangeably herein. In addition, the terms “reinforcing fiber material” and “reinforcing fiber”, and “reinforcement fiber” may be used interchangeably herein. Additionally, the terms “size”, “sizing composition”, and “size composition” may be interchangeably used.

The present invention relates to a sizing composition for reinforcement fibers. The size composition includes an end-capped, modified polyurethane dispersion, one or more silane coupling agents, and at least one lubricating surfactant. Optional components such as rheology modifiers, fillers, biocides, and pH modifiers may also be included in the size composition. In addition, the size composition is free of polyvinyl alcohol. The absence of polyvinyl alcohol in the size composition reduces or eliminates the production of precipitates (e.g., sludge) from the white water in a wet-laid process. Reducing the amount of sludge in the white water leads to an increase in manufacturing time in forming chopped strand mats because the mat production line does not have to be frequently shut down to clean the tanks.

The inventive size composition is applied to reinforcement fibers and formed into chopped strand, wet-laid mats that can be used for a variety of purposes, including roofing products such as shingles. It has been determined that chopped strand mats formed from fibers sized with the inventive sizing composition maintain or exceed the dry tear and tensile strengths compared to chopped strand mats made from fibers sized with commercial sizing compositions that do not contain a cationic modified polyurethane dispersion.

The sizing composition includes a cationically modified polyurethane dispersion as a film forming agent. Film formers are agents which create improved adhesion between the reinforcing fibers, which results in improved strand integrity. The cationically modified polyurethane is formed by first forming a prepolymer (precursor) by combining one or more polyols having a molecular weight in the range from 500-5,000, preferably a molecular weight from 1,000-3,000, and a polyisocyanate component in the presence of an optional catalyst and/or coalescing solvent. Suitable polyols include organic polyhydroxyl compounds such as polyether polyols, polyester polyols, polycarbonate, polyacrylate, lactone polyols, polyoxyalkylene polyols, polyoxycyloalkylene polyols, polythioethers, polybutadiene polyols, hydrogenated polybutadiene polyols, polycarbonate polyols, fluorinated polyether polyols, amine-terminated polyether polyols, and amine-terminated polyester polyols. Preferred polyols are polyester polyols and polyether polyols, and may be used alone or in combination.

The polyisocyanate component includes organic compounds that have two or more free isocyanate groups. Any suitable art-recognized diisocyanate or polyisocyanate may be used in the preparation of the precursor. The polyisocyanate component may be aromatic, aliphatic, cycloaliphatic, heterocyclic (or mixtures thereof); however, aromatic and aliphatic polyisocyanates are preferred. Additionally, the polyisocyanate component may be unsubstituted or substituted, such as with halogens. Non-limiting examples of suitable polyisocyanates include aliphatic compounds such as isophorone diisocyanate (IPDI), toluene-2,4-diisocyanate (TDI), diphenylmethane 4,4′-diisocyanate (MDI), hexamethylene 1,6-diisocyanate (HDI), bis(4-isocyanatocyclohexyl) methane (hydrogenated MDI), butylidene diisocyanate, trimethylene, tetramethylene, hexamethalene, cycloalkylene compounds such as 1,4-cyclohexane diisocyanate, aromatic compounds such as p-phenylene diisocyanate, aliphatic aromatic compounds such as 4,4′-diphenyl methane diisocyanate, 2,4- or 2,6-tolylene diisocyanate, and mixtures thereof. Preferred polyisocyates for use in the instant invention are isophorone diisocyanate (IPDI), toluene-2,4-diisocyanate (TDI), diphenylmethane 4,4′-diisocyanate (MDI), hexamethylene 1,6-diisocyanate (HDI), and bis(4-isocyanatocyclohexyl) methane (hydrogenated MDI).

It is desirable that the prepolymer contains more than one isocyanate radical in the reaction mixture for each active hydrogen radical contributed by the polyol component, the water solubilizing compound, and other isocyanate reactive components present in the prepolymer. Generally, isocyanate reactive groups having at least one active hydrogen include, but are not limited to, those selected from —OH, NH₂, —SH, and —NHR, where R is phenyl, straight or branched aliphatic groups having from about 1 to about 12 carbon atoms, or cycloaliphatic groups.

The polyurethane prepolymer thus prepared may be mixed with a chain extending agent in water to chain extend and fully develop the prepolymer and form a polyurethane dispersion. The prepolymer is fully developed when there is little or no residual free isocyanate in the mixture. A chain extender such as n-methyl diethanol amine, ethylene diamine, diethylene triamine, water, and/or hydrogen peroxide may be used to extend the prepolymer to a desired length and/or molecular weight. The length and/or weight of the polyurethane prepolymer is dependent upon the desired application of the final product. Desirably, the molecular weight of the polyurethane prepolymer falls in the range from 1,000-100,000, and even more desirably from 5,000-50,000. The prepolymer may be neutralized by neutralizing a tertiary nitrogen with an acid such as acidic acid or a compound that functions like an acid, such as dimethyl sulfate, to create a cationic charge in the polyurethane dispersion.

The prepolymer is terminated (i.e., end-capped) with a capping agent such as a silane, a blocking agent such as ketoxime, or both a capping agent and blocking agent. For example, the prepolymer may be terminated at both ends with a silane group by adding an amino silane such as N-(n-butyl)-3-aminopropyltrimethoxysilane to the polyurethane dispersion, preferably in the presence of a catalyst. Alternatively, the prepolymer may be terminated at both ends with a ketoxime group by adding methyl ethyl ketoxime (MEK) to the polyurethane dispersion, desirably in the presence of a catalyst. A blocking agent and a capping agent may be positioned at opposing ends of the prepolymer. Thus, a silane-terminated polyurethane, a ketoxime-terminated polyurethane, or a hybrid silane/ketoxime-terminated polyurethane where one end of the polyurethane is terminated with a silane group and the opposing end is terminated with a ketoxime group may be produced and utilized in the cationic polyurethane dispersion. The end-capped polyurethane may be present in the size composition in an amount from about 2.0% to about 50.0% by weight of the composition, preferably from about 5.0% to about 20.0% by weight of the composition.

As discussed above, the size composition also includes at least one silane coupling agent. Preferably, the sizing composition contains two or more silane coupling agents, or coupling agent package. The silane coupling agents may be present in the sizing composition in an amount from about 1.0% to about 40.0% by weight of the composition, preferably from about 2.0% to about 30.0% by weight of the composition, and most preferably from about 5.0% to about 15.0% by weight of the composition. Besides their role of coupling the surface of the reinforcement fibers and the plastic matrix, silanes also function to reduce the level of fuzz, or broken fiber filaments, during subsequent processing. Examples of silane coupling agents that may be used in the size composition may be characterized by the functional groups amino, epoxy, vinyl, methacryloxy, ureido, isocyanato, and mercapto. In preferred embodiments, the silane coupling agent(s) include silanes containing one or more nitrogen atoms that have one or more functional groups such as amine (primary, secondary, tertiary, and quaternary), amino, imino, amido, imido, ureido, or isocyanato.

Suitable silane coupling agents include, but are not limited to, amino silanes, silane esters, vinyl silanes, methacryloxy silanes, epoxy silanes, sulfur silanes, ureido silanes, isocyanato silanes, and mercapto silanes. Specific non-exclusive examples of silane coupling agents for use in the instant invention include γ-aminopropyltriethoxysilane (A-1100), n-phenyl-γ-aminopropyltrimethoxysilane (Y-9669), n-trimethoxy-silyl-propyl-ethylene-diamine (A-1120), methyl-trichlorosilane (A-154), γ-chloropropyl-trimethoxy-silane (A-143), vinyl-triacetoxy silane (A-188), methyltrimethoxysilane (A-1630), γ-ureidopropyltrimethoxysilane (A-1524), and vinyl aminosilanes (e.g., Z-6032 and Z-6224 available from Dow Corning). Other examples of suitable silane coupling agents are set forth in Table 1. All of the silane coupling agents identified above and in Table 1 except for Z-6032 and Z-6224 are available commercially from GE Silicones.

TABLE 1

| Silanes | Label |
|---|---|
| Silane Esters | |
| Octyltriethoxysilane | A-137 |
| Methyltriethoxysilane | A-162 |
| Methyltrimethoxysilane | A-163 |
| Vinyl Silanes | |
| Vinyltriethoxysilane | A-151 |
| Vinyltrimethoxysilane | A-171 |
| vinyl-tris-(2-methoxyethoxy) silane | A-172 |
| Methacryloxy Silanes | |
| γ-methacryloxypropyl- | A-174 |
| trimethoxysilane | |
| Epoxy Silanes | |
| β-(3,4-epoxycyclohexyl)- | A-186 |
| ethyltrimethoxysilane | |
| Sulfur Silanes | |
| γ-mercaptopropyltrimethoxysilane | A-189 |
| Amino Silanes | |
| γ-aminopropyltriethoxysilane | A-1101 |
| | A-1102 |
| Aminoalkyl silicone | A-1106 |
| γ-aminopropyltrimethoxysilane | A-1110 |
| triaminofunctional silane | A-1130 |
| bis-(γ-trimethoxysilylpropyl)amine | A-1170 |
| polyazamide silylated silane | A-1387 |
| Ureido Silanes | |
| γ-ureidopropyltrialkoxysilane | A-1160 |
| γ-ureidopropyltrimethoxysilane | Y-11542 |
| Isocyanato Silanes | |
| γ-isocyanatopropyltriethoxysilane | A-1310 |

In preferred embodiments, the silane coupling agents include both an amino silane and a ureido silane. Even more desirably, the amino silane contains one or more aromatic amines. The presence of aromatic amines on the silane coupling agent assists in bonding the reinforcement fiber (e.g., glass fibers) to the film forming resin. In addition, the aromatic amines interact with the asphalt and can further function as a compatabilizer between the chopped strand mat and the asphalt in roofing applications. It is believed that the combination of an amino silane and a ureido silane causes dry tear and tensile strengths of chopped strand mats formed from fibers sized with the inventive sizing composition to be equivalent to or superior than existing chopped strand mats formed from fibers sized with conventional sizing compositions that do not contain a cationic modified polyurethane dispersion.

In addition, the size composition includes at least one lubricating surfactant that is water soluble, dispersible, or emulsifiable to facilitate fiber manufacturing, processing, and fabrication. The lubricating surfactant(s) may be present in the size composition in an amount from about 10.0% to about 90.0% by weight of the total composition, preferably from about 20.0% to about 80.0% by weight of the total composition, and more preferably about 40.0% to about 60% by weight of the total composition. Each lubricating surfactant may be added in an amount from about 1.0% to about 60.0% by weight of the total composition, preferably in an amount from about 10.0% to about 50.0.0% by weight. Non-exclusive examples of lubricating surfactants for use in the sizing composition include polyoxamines (e.g., an ethylene oxide/propylene oxide block polymer (e.g., Tetronic® 908, commercially available from BASF Corporation)), stearic ethanolamide (Lubesize K-12, commercially available from AOC, LLC), polyethylene glycol esters, ethoxylated castor oil esters, aliphatic mono-, di-, and poly-amines (e.g., N-alkyl trimethylenediamine, 2-alkyl-2-imidazoline and 1-(2-aminoethyl)-2-alkyl-2-imidazoline), amine ethoxylates (e.g., Alkaminox T-12 and Katapol PN-430, commercially available from Rhodia), and cationic fatty amides (e.g., Emory 7484 and Emory 6717, commercially available from Cognis).

The size composition further includes water to dissolve or disperse the active solids for application onto the reinforcement fibers. Water may be added in an amount sufficient to dilute the aqueous sizing composition to a viscosity that is suitable for its application to the reinforcement fibers and to achieve a desired solids content on the fibers. In particular, the size composition may contain up to about 99.5% by weight of the total composition of water.

In addition, the size composition may optionally include a pH adjusting agent in an amount sufficient to adjust the pH to a desired level. Suitable pH adjusting agents include weak organic acids such as acetic acid, citric acid, sulfuric acid, or phosphoric acid or a base such as ammonia or sodium hydroxide. The pH may be adjusted depending on the intended application, or to facilitate the compatibility of the ingredients of the size composition. Preferably, the sizing composition has a pH from 3-7, and more preferably a pH from 4-6.

Further, the size composition may optionally contain conventional additives such as rheology modifiers, fillers, coalescents such as glycols and glycol ethers to aid in fiber storage stability, biocides such as Amerstat 250 and Amerstat 251 (commercially available from Ashland Chemicals) and Nalco 9380 (commercially available from ONDEO), viscosity modifiers such as Nalco 7530 (commercially available from ONDEO), antifoaming agents such as Drew L-139 (commercially available from Drew Industries, a division of Ashland Chemical), antistatic agents such as Emerstat 6660A (commercially available from Cognis), dyes, oils, thermal stabilizers, anti-foaming agents, anti-oxidants, dust suppression agents, wetting agents, thickening agents, and/or other conventional additives. Additives may be present in the size composition from trace amounts (such as <about 0.1% by weight the total composition) up to about 5.0% by weight of the total composition.

The size composition may be made by adding the silane or silane coupling agent package and deionized water in a container with agitation to hydrolyze the silane coupling agent(s). As described above, weak acids may be added to assist in hydrolyzing the silane coupling agent(s). After the hydrolyzation of the silane coupling agent(s), the cationic polyurethane dispersion and lubricating surfactants, along with any desired additives, are added to form a mixture. If necessary, the pH of the mixture may be adjusted to a desired level. The cationic polyurethane dispersion and lubricating surfactants (as well as any additives) may be added separately, or they may be added at the same time to form the main mixture.

The inventive sizing composition may be used to treat a reinforcing fiber. Any type of glass, such as A-type glass fibers, C-type glass fibers, E-type glass fibers, S-type glass fibers, ECR-type glass fibers (e.g., Advantex® glass fibers commercially available from Owens Corning), Hiper-tex™, wool glass fibers, or combinations thereof may be used as the reinforcing fiber. In at least one preferred embodiment, the glass fibers are wet use chopped strand glass fibers (WUCS). Wet use chopped strand glass fibers may be formed by conventional processes known in the art. It is desirable that the wet use chopped strand glass fibers have a moisture content from about 5% to about 30%, and even more desirably a moisture content from about 10% to about 20%.

WUCS fibers are a low cost reinforcement that provides impact resistance, dimensional stability, and improved mechanical properties such as improved strength and stiffness to the finished product. Further, with WUCS, the final product has the mechanical properties to take nails and screws in construction processes without cracking or other mechanical failures. In addition, WUCS fibers are easily mixed and may be fully dispersed or nearly fully dispersed in the white water of a wet-laid process.

Alternatively, the reinforcing fiber may be fibers of one or more synthetic polymers such as polyester, polyamide, aramid, and mixtures thereof. The polymer strands may be used alone as the reinforcing fiber material, or they can be used in combination with glass fibers such as those described above. As a further alternative, natural fibers may be used as the reinforcing fiber material. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof. Carbon or polyaramide fibers may be also used as the reinforcing fiber material. In preferred embodiments, all of the reinforcing fibers are glass fibers, and most preferably are wet use chopped strand fibers (WUCS).

The inventive sizing composition may be applied to the reinforcing fibers with a Loss on Ignition (LOI) from 0.01% to 0.5% by weight on the dried fiber, and preferably from 0.05% to 0.30% by weight. This can be determined by the loss on ignition (LOI) of the reinforcing fibers, which is the reduction in weight experienced by the fibers after heating them to a temperature sufficient to burn or pyrolyze the organic size from the fibers. As used in conjunction with this application, LOI may be defined as the percentage of organic solid matter deposited on the reinforcement fiber surfaces.

The reinforcing fiber may include fibers that have a diameter from about 5.0 microns to about 30.0 microns and may be cut into segments having a discrete length of approximately 5.0 mm to about 50.0 mm in length. Preferably, the fibers have a diameter from about 10.0 microns to about 20.0 microns and a length from about 20 mm to about 35 mm. If the reinforcement fibers are WUCS, they may have a length of about ⅛ of an inch to about 2 inches and preferably a length from about ½ of an inch to about 1.5 inches. Each chopped strand may contain from approximately 500 fibers to approximately 8,000 fibers.

A non-woven chopped strand mat of the sized reinforcement fibers (e.g., a roofing mat) may be formed by a wet-laid process. Although any or a combination of the reinforcing fibers described herein may be used to form the chopped strand mat, it is to be noted that the exemplary process described herein is with respect to a preferred embodiment in which all of the reinforcement fibers are glass fibers. As is known in the art, glass fibers may be formed by attenuating streams of a molten glass material through a heated bushing to form substantially continuous glass fibers. As the fibers are drawn from the bushing, the inventive sizing composition is applied to the fibers. The size composition may be applied to the reinforcing fibers by any conventional method, including kiss roll, dip-draw, slide, or spray application to achieve the desired amount of the sizing composition on the fibers.

After the glass fibers are treated with the sizing composition, they are collected into a strand and chopped into discrete lengths. It is also within the purview of the invention to chop the individual fibers into discrete lengths and feed the chopped fibers into the white water. Any suitable method or apparatus known to those of ordinary skill for chopping glass fiber strands into segments, such as a cutter/cot combination, may be used to chop or cut the strands. The specific number of individual fibers present in the chopped strands will vary depending on the particular application of the chopped strand mat and the desired strength and thickness of the mat. The wet, chopped glass fiber strands are collected in a container.

The chopped glass strands may be placed into a mixing tank that contains various surfactants, viscosity modifiers, defoaming agents, and/or other chemical agents (i.e., white water) with agitation to form a chopped glass fiber slurry. The white water may be passed through a machine chest and a constant level chest to further disperse the glass fibers. The chopped glass fiber slurry may then be transferred from the constant level chest to a head box where the slurry is deposited onto a moving screen or foraminous conveyor and a substantial portion of the water from the slurry is removed to form a web of enmeshed fibers. Water may be removed from the web by a conventional vacuum or air suction system. A binder is then applied to the web by a suitable binder applicator, such as a curtain coater. The binder-coated web is then passed through one or more drying ovens to remove any remaining water, cure the binder, and form a chopped strand mat. The formed non-woven, chopped strand mat is an assembly of randomly oriented, dispersed, individual glass fibers.

The binder may be an acrylic binder, a styrene acrylonitrile binder, a styrene butadiene rubber binder, a urea formaldehyde binder, a polyacrylic binder, a urea-melamine binder, or mixtures thereof. A thermosetting urea formaldehyde binder is generally the most preferred binder due to its low cost. The urea formaldehyde binder may be modified with a styrene-butadiene rubber latex, an acrylic emulsion, or a styrene/acrylic emulsion to adjust the adhesion and mechanical properties of the binder. Non-exclusive examples of suitable urea formaldehyde resins include Casco-Resin FG-472×(available commercially by Hexion), GP-2928 and GP-2981 (available commercially from Georgia Pacific Resins), and Dynea Prefere 2118-54 (available commercially from Dynea). Examples of acrylic emulsion binders include, but are not necessarily limited to, Rhoplex GL-618 and Rhoplex GL-720 (available commercially from Rohm & Haas), and Acronal DS 2396 (available commercially from BASF). A suitable example of a styrene-butadiene rubber latex includes 490NA from Dow Reichhold. The binder may optionally contain conventional additives for the improvement of process and product performance such as dyes, oils, fillers, colorants, UV stabilizers, coupling agents (e.g., aminosilanes), lubricants, wetting agents, surfactants, and/or antistatic agents.

In preferred embodiments, glass fibers are sized with the inventive sizing composition and packaged as wet use chopped strand glass that are subsequently used to form reinforced building or roofing composites, such as shingles or built-up roofing. To form a shingle, a chopped strand mat (e.g., formed with sized WUCS glass fibers) such as is described in detail above is first formed. Asphalt is then applied to the dried/cured mat by any known manner, such as by passing the mat through a bath containing an asphalt mix that may include molten asphalt, fillers, and optionally sulfur to place a layer of asphalt on at least one side of the mat and fill in the interstices between the individual glass fibers. The asphalt-coated mat is then cut to the appropriate shape and size to form a shingle. The hot asphalt-coated mat may then be passed beneath one or more granule applicators which apply protective surface granules to portions of the asphalt-coated mat prior to cutting into the desired shape. It is to be appreciated that wet-laid mats formed with fibers sized with the inventive sizing composition may also be used for backing and flooring materials, or anywhere where good tensile strength is required.

The sizing composition of the present invention provides numerous advantages over conventional sizing compositions for fibers used to form roofing products. For example, the polyurethane end-capped with silane groups can react with the —OH groups present on the glass surface to provide crosslinking between the film former (resin) and the glass surface, and the film former remains on the glass fiber surface after the subsequent mat conversion process in the white water. On the other hand, prepolymers end-capped with ketoxime groups will regenerate —NCO groups through a de-blocking reaction when a wet web (such as is described in detail above) is dried in an oven. These regenerated —NCO groups may then react with the urea formaldehyde binder on the mat. Thus, a prepolymer (polyurethane) end-capped with both a silane group and a ketoxime group may be viewed as a polyurethane-based elastomeric coupling agent to bond the glass to the resin matrix. Such a “polyurethane-based elastomer” advantageously absorbs energy and improves the tear resistance of the final product (e.g., roofing product or shingle).

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Synthesis of Silylated Polyurethane Dispersion (SPUD)

The components set forth in Tables 2 and 3 were utilized to synthesize a silylated polyurethane dispersion (SPUD). In particular, the components form a polyurethane end-capped at opposing ends by a silane group and a ketoxime group.

TABLE 2
Polyurethane Precursor Synthesis Components

| | Kettle | | | |
|---|---|---|---|---|
| | Charge | Charge 1 | Charge 2 | Charge 3 |
| | (g) | (g) | (g) | (g) |
| Fomrez 55-56⁽¹⁾ | 110.0 | | | |
| Voranol 220-56⁽²⁾ | 110.0 | | | |
| DES IPDI⁽³⁾ | 199.3 | | | |
| 2% T-12 in n-MP⁽⁴⁾ | 2.4 | | | |
| n-MP #1⁽⁵⁾ | | 57.2 | | |
| n-MDEA⁽⁶⁾ | | 45.7 | | |
| n-MP #2 | | | 62.7 | |
| Dynasylan 1189⁽⁷⁾ | | | 23.7 | |
| MEK⁽⁸⁾ | | | 8.7 | |
| n-MP #3 | | | | 454.8 |

⁽¹⁾polyester polyol (Chemtura)
⁽²⁾polyether polyol (Dow Chemicals)
⁽³⁾isophorone diisocyanate (Bayer)
⁽⁴⁾2% T-12: dibutyl tin dilaurate (Aldrich)
⁽⁵⁾1-methyl pyrrolidinone (Aldrich)
⁽⁶⁾n-methyldiethanol amine (Aldrich)
⁽⁷⁾N-(n-butyl)-3-aminopropyltrimethoxysilane (Degussa)
⁽⁸⁾methyl ethyl ketoxime

The polyester polyol and the polyether polyol (110 g each) were added to a kettle and mixed at room temperature. The polyol mixture was then purged with N₂ for 10 minutes. After 10 minutes had elapsed, the temperature of the kettle was gradually heated to a 40-45° C. The isophorone diisocyanate was added to the polyol mixture and the temperature was raised to 70° C. At 70° C., 2.4 g of dibutyl tin dilaurate catalyst was added and the temperature was adjusted to 93-95° C. and held at that temperature for 30 minutes.

After 30 minutes had elapsed, the Charge 1 components (i.e., 1-methyl pyrrolidinone and n-methyldiethanol amine) were added to the polyurethane precursor mixture over a period of 15 minutes. The polyurethane mixture containing an extended polyurethane was cooled to a temperature of 95-96° C. and maintained at a temperature from 95-96° C. for 90 minutes.

Next, 1-methylpyrrolidinone, N-(n-butyl)-3-aminopropyltrimethoxysilane, and methyl ethyl ketoxime (i.e., Charge 2 components) were added with mixing over a period of 15 minutes to end-cap the extended polyurethane precursor with an silane group and a ketoxime group. This mixture was then held at a temperature of 95-96° C. for 90 minutes with stirring. After the 90 minute holding period, the components of Charge 3 (i.e., 1-methyl pyrrolidoline and acetic acid) were added to the kettle over a time period of 30 minutes. The thus formed mixture was mixed for an additional 10 minutes at a temperature from 60-65° C. The end-capped polyurethane prepolymer solution was then cooled to room temperature.

TABLE 3
Dispersion Preparation Components

| | (g) |
|---|---|
| Part A | |
| End-capped Polyurethane | 400 |
| Solution | |
| DMS⁽⁹⁾ | 16.0 |
| Part B | |
| Deionized Water | 400 |
| Acetic Acid | 4.0 |
| Dispelair CF-907⁽¹⁰⁾ | 1.0 |

⁽⁹⁾Dimethyl sulfate (Aldrich)
⁽¹⁰⁾Defoamer (Blackburn Chemicals, LTD.)

To prepare the cationic modified polyurethane dispersion, 400 g of deionized water, 4.0 of acetic acid, and 1.0 g of the defoamer (i.e., the components of Part B of Table 3) were mixed and adjusted to a temperature of about 30° C. 16.0 g of dimethyl sulfate was added to 400 g of the end-capped polyurethane solution (Part A shown in Table 3) to neutralize the polyurethane prepolymer dispersion and from a cationic charge in the dispersion. Part A was then added to Part B over 10 minutes, after which the temperature was raised to 55-60° C. and maintained for three hours. The cationic silane/ketoxime end-capped polyurethane dispersion (SPUD) was discharged and filtered through 100 mesh cheese cloth.

TABLE 4
Properties of Cationic Silylated Polyurethane Dispersion (SPUD)

| | |
|---|---|
| Solids (%) | 21.20 |
| pH | 5.62 |
| Viscosity | 150 |
| (cps)⁽¹¹⁾ | |

⁽¹¹⁾#2@60, LVT

### Example 2

### Performance Properties

### Comparative Example A

The cationic silane/ketoxime end-capped polyurethane dispersion was used to form a sizing composition for wet use chopped strand glass fibers (WUCS). The inventive size formulations are set forth in Tables 5 and 7. A comparative size formulation is set forth in Table 6.

TABLE 5
Inventive SPUD-Modified Size Composition #1

| | % | | Mass Solid | As Received |
|---|---|---|---|---|
| Material | Solids | Fraction | 80 g per 100 g | (g) |
| Nalco 7530⁽¹⁾ | 25.50 | 0.0100 | 0.5466 | 2.14 |
| GP-2925⁽²⁾ | 20.00 | 0.1000 | 5.4661 | 27.33 |
| OC 6954-67 A/CD⁽³⁾ | 21.20 | 0.3000 | 16.3982 | 77.35 |
| Tetronic 908⁽⁴⁾ | 15.00 | 0.2000 | 10.9321 | 72.88 |
| Y-9669⁽⁵⁾ | 82.00 | 0.0300 | 1.6398 | 2.00 |
| Lubesize K-12⁽⁶⁾ | 8.80 | 0.6930 | 37.8798 | 430.45 |
| A-1524⁽⁷⁾ | 81.00 | 0.1350 | 7.3792 | 9.11 |
| Ameristat 251⁽⁸⁾ | 1.50 | 0.00015 | 0.0082 | 0.55 |
| D.M. Water | 0.00 | 0.000 | 0.000 | 6880.33 |
| | | 1.4682 | 80.2500 | 7500.00 |

⁽¹⁾viscosity modifier (ONDEO)
⁽²⁾polyamide resin (Georgia Pacific Resins)
⁽³⁾cationic silane/ketoxime end-capped polyurethane dispersion from Example 1
⁽⁴⁾surfactant (BASF Corporation)
⁽⁵⁾n-phenyl-γ-aminopropyltrimethoxysilane (GE Silicones)
⁽⁶⁾lubricant (AOC, LLC)
⁽⁷⁾γ-ureidopropyltrimethoxysilane (GE Silicones)
⁽⁸⁾biocide (Ashland Chemicals)

The size composition of Table 5 was formed by mixing the individual components together in a conventional manner. 1.0 g of acetic acid was used to assist in the hydrolysis of the silane coupling agents, which decreased the pH of the mixture to 4.22. Once the components were thoroughly mixed, approximately 3.0 g of (NH)₄OH was added to raise the pH of the size composition to 5.62. The mix solids target was 1.07.

The size composition of Table 5 (i.e., inventive sizing formulation) and OC 9550 commercial size composition, which contains a polyamide resin film former and no SPUD (i.e., control sizing formulation #1), were applied to WUCS fibers and the fibers were converted into roofing mats and shingle samples to evaluate performance properties. The results of these comparisons are summarized in Table 8.

### Comparative Example B

TABLE 6
Control Size Composition #2

| | | | Mass Solid | As Received |
|---|---|---|---|---|
| Material | % Solids | Fraction | 80 g per 100 g | (g) |
| Nalco 7530⁽¹⁾ | 25.50 | 0.0100 | 0.0119 | 3.75 |
| GP-2925⁽²⁾ | 20.00 | 1.2000 | 19.1037 | 95.52 |
| Tetronic 908⁽³⁾ | 15.00 | 0.4000 | 38.2075 | 254.72 |
| Y-9669⁽⁴⁾ | 82.00 | 0.0300 | 2.8656 | 3.49 |
| Z-6032⁽⁵⁾ | 42.00 | 0.0300 | 2.8656 | 6.82 |
| CAT-X⁽⁶⁾ | 6.37 | 0.0800 | 7.6415 | 119.96 |
| A-1524⁽⁷⁾ | 81.00 | 0.0900 | 8.5967 | 10.61 |
| Ameristat 251⁽⁸⁾ | 1.50 | 0.00015 | 0.0143 | 0.96 |
| D.M. Water | | | | 7007.92 |
| | | 0.8402 | 80.2500 | 7500.00 |

⁽¹⁾viscosity modifier (ONDEO)
⁽²⁾polyamide resin (Georgia Pacific Resins)
⁽³⁾surfactant (BASF Corporation)
⁽⁴⁾n-phenyl-γ-aminopropyltrimethoxysilane (GE Silicones)
⁽⁵⁾vinyl aminosilanes (Dow Corning)
⁽⁶⁾cationic lubricant (Eastman Chemical)
⁽⁷⁾γ-ureidopropyltrimethoxysilane (GE Silicones)
⁽⁸⁾biocide (Ashland Chemicals)

The size composition of Table 6 (i.e., Control Formulation 2) was formed by mixing the individual components together in a conventional manner. 1.0 g of acetic acid was used to assist in the hydrolysis of the silane coupling agents, which decreased the pH of the mixture to 4.21. Once the components were thoroughly mixed, approximately 3.5 g of (NH)₄OH was added to raise the pH of the size composition to 6.43. The mix solids target was 1.07.

TABLE 7
Inventive SPUD-Modified Size Composition #2

| | % | | Mass Solid | As Received |
|---|---|---|---|---|
| Material | Solids | Fraction | 80 g per 100 g | (g) |
| Nalco 7530⁽¹⁾ | 25.50 | 0.0100 | 0.9552 | 3.75 |
| GP-2925⁽²⁾ | 20.00 | 0.1500 | 14.3278 | 71.64 |
| OC 6954-67 A/CD⁽³⁾ | 21.20 | 0.1500 | 14.2378 | 67.58 |
| Tetronic 908⁽⁴⁾ | 15.00 | 0.3000 | 28.6556 | 191.04 |
| Y-9669⁽⁵⁾ | 82.00 | 0.0300 | 2.8656 | 3.49 |
| Z-6032⁽⁶⁾ | 42.00 | 0.0300 | 2.8656 | 6.82 |
| CAT-X⁽⁷⁾ | 6.37 | 0.0800 | 7.6415 | 119.96 |
| A-1524⁽⁸⁾ | 81.00 | 0.0900 | 8.5967 | 10.61 |
| Ameristat 251⁽⁹⁾ | 1.50 | 0.00015 | 0.0143 | 0.96 |
| D.M. Water | | | | 7027.89 |
| | | 0.8402 | 80.2500 | 7500.00 |

⁽¹⁾viscosity modifier (ONDEO)
⁽²⁾polyamide resin (Georgia Pacific Resins)
⁽³⁾cationic silane/ketoxime end-capped polyurethane dispersion from Example 1
⁽⁴⁾surfactant (BASF Corporation)
⁽⁵⁾n-phenyl-γ-aminopropyltrimethoxysilane (GE Silicones)
⁽⁶⁾vinyl aminosilanes (Dow Corning)
⁽⁷⁾cationic lubricant (Eastman Chemical)
⁽⁸⁾γ-ureidopropyltrimethoxysilane (GE Silicones)
⁽⁹⁾biocide (Ashland Chemicals)

The inventive size composition of Table 7 was formed by mixing the individual components together in a conventional manner. 1.0 g of acetic acid was used to assist in the hydrolysis of the silane coupling agents, which decreased the pH of the mixture to 4.23. Once the components were thoroughly mixed, approximately 3.0 g of (NH)₄OH was added to raise the pH of the size composition to 6.04. The mix solids target was 1.07.

The conventional size composition of Table 6 and the inventive size formulation of Table 7 were individually applied to WUCS fibers and the fibers were converted into roofing mats and shingle samples to evaluate performance properties. The results of these performance comparisons are summarized in Table 8.

TABLE 8
Performance Property Comparisons

| | | SPUD- | | SPUD- |
|---|---|---|---|---|
| | Control | Modified | Control | Modified |
| | Formulation | Formulation | Formulation | Formulation |
| | 1 | 1 | 2 | 2 |
| Mat Properties | | | | |
| MD Tensile, lb | 68.5 | 64.8 | 85.7 | 76.1 |
| Total Tensile, | 108.1 | 104.2 | 136.9 | 116.1 |
| lb | | | | |
| CD Tear, g | 867 | 921 | 765 | 829 |
| Total Tear, g | 1551 | 1592 | 1265 | 1417 |
| Hot Wet | 73.2 | 85.9 | 68.0 | 77.0 |
| Retention, % | | | | |
| Shingle | | | | |
| Properties | | | | |
| CD Tear, g | 1992 | 2124 | 1830 | 2128 |
| Total Tear, g | 3481 | 3693 | 3263 | 3779 |
| MD Tensile, lb | 234 | 254 | 235 | 257 |

As shown in Table 8, the inclusion of the silane/ketoxime end-capped polyurethane dispersion in the modified sizing compositions resulted in improved tear performance in both the roofing mats and the shingles. It can also be seen that the SPUD addition resulted in an improvement in the hot wet retention of the chopped strand mat. Looking at the tensile strengths, the SPUD-Modified Formulation 1 performed at least as well as the control formulation.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1-20. (canceled)

21. A sizing composition for reinforcement fibers used to form wet-laid chopped strand mats comprising:
a cationic modified polyurethane dispersion, the polyurethane in this dispersion including a polyurethane terminated at one end with a capping agent at another end with a blocking agent;
at least one silane coupling agent; and
one or more lubricating surfactants.

22. The sizing composition of claim 21, wherein the polyurethane is terminated at one end with a silane end capping group and terminated at another end with a ketoxime blocking group.

23. The sizing composition of claim 22, wherein the at least one silane coupling agent comprises an aminosilane and a ureido silane.

24. The sizing composition of claim 23, wherein the aminosilane contains an aromatic amine.

25. The sizing composition of claim 21, wherein the at least one silane coupling agent comprises an aminosilane and a ureido silane.

26. The sizing composition of claim 25, wherein the aminosilane contains an aromatic amine.

27. The sizing composition of claim 21, wherein the one or more lubricating surfactants are selected from the group consisting of an ethylene oxide/propylene oxide block polymer, steraic ethanolamide, polyurethane glycol esters, ethoxylated caster oil esters, aliphatic monoamines, aromatic diamines, aromatic polyamines, amine ethoxylates and cationic fatty amides.

28. The sizing composition of claim 21, further comprising one or more rheology modifiers, biocides fillers, coalescents, antistatic agents, dyes, oils, thermal stabilizers, anti-foaming agents, antioxidants, dust suppression agents, wetting agents and thickening agents.

29. The sizing composition of claim 21, wherein:
the cationic modified polyurethane dispersion is present in the sizing composition in an amount from about 2% to about 50% by weight of the sizing composition on a dry weight basis;
the at least one silane coupling agent is present in the sizing composition in an amount from about 1% to about 40% by weight of the sizing composition on a dry weight basis; and
the one or more lubricating surfactants is present in the sizing composition in an amount from about 20% to about 80% by weight of the sizing composition on a dry weight basis.

30. The sizing composition of claim 29, wherein:
the cationic modified polyurethane dispersion is present in the sizing composition in an amount from about 5% to about 20% by weight of the sizing composition on a dry weight basis;
the at least one silane coupling agent is present in the sizing composition in an amount from about 2% to about 30% by weight of the sizing composition on a dry weight basis; and
the one or more lubricating surfactants is present in the sizing composition in an amount from about 40% to about 60% by weight of the sizing composition on a dry weight basis.

31. A reinforcement fiber for use in forming a non-woven chopped strand mat for forming a roofing material comprising:
a wet use chop strand fiber at least partially coated with a sizing composition including:
a cationic modified polyurethane dispersion including a polyurethane terminated at one end with a silane group and at another end with a ketoxime group;
at least one silane coupling agent; and
one or more lubricating surfactants.

32. The reinforcement fiber of claim 31, wherein the at least one silane coupling agent comprises an aminosilane and a ureido silane.

33. The reinforcing fiber of claim 32, wherein the aminosilane contains an aromatic amine.

34. The reinforcing fiber of claim 31, wherein the one or more lubricating surfactants is selected from the group consisting of an ethylene oxide/propylene oxide block polymer, steraic ethanolamide, polyurethane glycol esters, ethoxylated caster oil esters, aliphatic monoamines, aromatic diamines, aromatic polyamines, amine ethoxylates and cationic fatty amides.

35. The reinforcement fiber of claim 31, wherein:
the cationic modified polyurethane dispersion is present in the sizing composition in an amount from about 2% to about 50% by weight of the sizing composition on a dry weight basis;
the at least one silane coupling agent is present in the sizing composition in an amount from about 1% to about 40% by weight of the sizing composition on a dry weight basis; and
the one or more lubricating surfactants is present in the sizing composition in an amount from about 20% to about 80% by weight of the sizing composition on a dry weight basis.

36. The reinforcement fiber of claim 35, wherein:
the cationic modified polyurethane dispersion is present in the sizing composition in an amount from about 5% to about 20% by weight of the sizing composition on a dry weight basis;
the at least one silane coupling agent is present in the sizing composition in an amount from about 2% to about 30% by weight of the sizing composition on a dry weight basis; and
the one or more lubricating surfactants is present in the sizing composition in an amount from about 40% to about 60% by weight of the sizing composition on a dry weight basis.

37. A roofing mat comprising:
a plurality of randomly oriented glass fibers having a discrete length enmeshed in the form of a mat having a first major surface and a second major surface, the glass fibers being at least partially coated with a sizing composition including:
a cationic modified polyurethane dispersion, the polyurethane in this dispersion including a polyurethane terminated at one end with a capping agent and at another end with a blocking agent;
at least one silane coupling agent; and
one or more lubricating surfactants; and
a binder composition at least partially coating the first major surface of the mat.

38. The roofing mat of claim 37, wherein the polyurethane is terminated at one end with a silane end capping group and terminated at another end with a ketoxime blocking group.

39. The roofing mat of claim 38, wherein at least one silane coupling agent comprises an aminosilane and a ureido silane.

40. The roofing mat of claim 39, wherein the aminosilane contains an aromatic amine.

41. The roofing mat of claim 37, wherein at least one silane coupling agent comprises an aminosilane and a ureido silane.

42. The roofing mat of claim 41, wherein the aminosilane contains an aromatic amine.

43. The roofing mat of claim 37, wherein the one or more lubricating surfactants is selected from the group consisting of an ethylene oxide/propylene oxide block polymer, steraic ethanolamide, polyurethane glycol esters, ethoxylated caster oil esters, aliphatic monoamines, aromatic diamines, aromatic polyamines, amine ethoxylates and cationic fatty amides.

44. The roofing mat of claim 37, further comprising one or more rheology modifiers, biocides fillers, coalescents, antistatic agents, dyes, oils, thermal stabilizers, anti-foaming agents, antioxidants, dust suppression agents, wetting agents and thickening agents.

45. The roofing mat of claim 37, wherein:
the cationic modified polyurethane dispersion is present in the sizing composition in an amount from about 2% to about 50% by weight of the sizing composition on a dry weight basis;
the at least one silane coupling agent is present in the sizing composition in an amount from about 1% to about 40% by weight of the sizing composition on a dry weight basis; and
the one or more lubricating surfactants is present in the sizing composition in an amount from about 20% to about 80% by weight of the sizing composition on a dry weight basis.

46. The roofing mat of claim 45, wherein:
the cationic modified polyurethane dispersion is present in the sizing composition in an amount from about 5% to about 20% by weight of the sizing composition on a dry weight basis;
the at least one silane coupling agent is present in the sizing composition in an amount from about 2% to about 30% by weight of the sizing composition on a dry weight basis; and
the one or more lubricating surfactants is present in the sizing composition in an amount from about 40% to about 60% by weight of the sizing composition on a dry weight basis.

47. The roofing mat of claim 37, further comprising an asphalt coating on at least a portion of the second major surface of the mat.
